(19) United States
(12) Patent Application Publication
(10) Pub. No.: US 2010/0116912 A1
(43) Pub. Date: May 13, 2010

(54) FUEL INJECTOR

(76) Inventors: Motonari Yarino, Shizuoka (JP); Tomojiro Sugimoto, Shizuoka (JP); Shouji Miyazaki, Shizuoka (JP); Takehiro Nitoh, Shizuoka (JP); Atsushi Shirasawa, Shizuoka (JP); Kazuaki Satoh, Shizuoka (JP); Eriko Matsumura, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/445,324

(22) PCT Filed: Oct. 30, 2007
(86) PCT No.: PCT/JP2007/071444

§ 371 Date: Apr. 13, 2009

(30) Foreign Application Priority Data
Oct. 30, 2006 (JP) 2006-294515

(51) Int. Cl. B05B 1/30

(52) U.S. Cl. 239/584

(57) ABSTRACT

A fuel injector inhibiting adhesion of deposits and simultaneously improving durability by a simple configuration is provided.

A fuel injector having
a valve body provided with a main space receiving fuel and an injection hole and
a needle movably supported at the valve body and having a seal part at its front end, in which needle the movement causes the seal part to separate from or contact an inner surface of the valve body and thereby open or close a fuel passage communicating the main space and the injection hole of the valve body,
the fuel injector characterized in that
the injection hole of the valve body is covered by an injection hole coating comprised of a material with a lower adsorption and reactivity with oxygen compared with the material of the valve body itself, and
the seal part of the needle is covered by a seal part coating comprised of a material higher in liquid-repellency compared with the material of the needle itself and not forming a metal surface. Preferably, the material of the injection hole coating is gold and the material of the seal part coating is a silica-based coating material.

### TECHNICAL FIELD

The present invention relates to a fuel injector of an in-line injector type internal combustion engine.

### BACKGROUND ART

In the past, there has been known an in-line injector type internal combustion engine directly injecting fuel into a combustion chamber. Each fuel injector injects fuel into a combustion chamber in accordance with the operating conditions at the necessary timing.

In the combustion chamber, the injected atomized fuel is mixed with the air. The air-fuel mixture formed is ignited by the spark plug and burned.

A fuel injector of an in-line injector type internal combustion engine typically is comprised provided with

a valve body provided with a main space receiving fuel, a sack part serving as a fuel reservoir, and an injection hole arranged in that order and

a needle movably supported at the valve body and having a seal part at its front end, in which needle the movement causes the seal part to separate from or contact an inner surface of the valve body and thereby open or close a fuel passage communicating the main space and the sack part of the valve body.

If the needle moves at a predetermined timing to separate the inner surface of the valve body and the seal part of the front end of the needle and open the fuel passage between the two, the main space and the sack part are communicated and fuel passes through the fuel passage and is injected through the sack part from the injection hole to the inside of the combustion chamber.

In such a fuel injector, a predetermined amount of fuel is once filled into the sack part, then is injected through the injection hole, so even if the fuel injection period elapses and the needle closes the fuel passage, not yet injected fuel remains inside the sack part.

The residual fuel in the sack part is roasted by the combustion gas whereby the inner surface of the sack part, the front end face of the needle (in particular the seal part), etc. end up with deposits derived from the fuel (oxides, carbides, decomposed products, etc.) adhering to them. The adhering deposits narrow the flow area of the fuel passage and become flow resistances to the fuel. They cause a drop in the flow and cause fluctuations in the amount of fuel injection and are liable to cause deteriorated combustion. Further, if deposits further adhere, they are even liable to plug up the injection hole.

In the past, to solve such a problem, for example, it has been proposed to coat the surface of the injection hole of a fuel injector with a fluororesin (Japanese Patent Publication (A) No. 2003-503637) or to coat it with a coated solution including a metal alkoxide and a fluoroalkyl group-substituted alkoxide where part of the alkoxyl groups is substituted by fluoroalkyl groups and to fire this to obtain a coated film inhibiting adhesion of deposits (Japanese Patent No. 3156610).

Alternatively, it has been proposed to coat the surface of a fuel injector with an FAS film formed by the so-called sol-gel method hydrolyzing and polymerizing an alkyl trialkoxysilane having a fluoroalkyl group (Japanese Patent Publication (A) No. 2004-84499).

Further, it has been proposed to provide the valve seat of a needle or the surface of the needle with a resin or metal or other coating lowering the surface energy or reducing the surface reactivity (Japanese Patent Publication (A) No. 2002-543330).

Furthermore, it has been proposed to provide a valve seat of a needle with an insert formed by a ceramic material delaying adhesion of deposits (Japanese Patent Publication (A) No. 2001-280224).

However, the above proposed fuel injectors had the following problems.

The fuel injector according to Japanese Patent Publication (A) No. 2003-503637 had an injection hole facing the combustion chamber and exposed to a high temperature, so with a fluororesin, the durability was liable to be insufficient. If part of the resin coating became damaged and dropped off, deposits were liable to form starting from the dropped off parts.

Further, the fuel injector according to Japanese Patent No. 3156610 had a coating with a low adsorption energy, so if effectively formed, there would be a high effect in inhibiting the formation of deposits, but the coating was carbon-based and was extremely thin, so depending on the surface conditions of the coating, the durability was liable to fall.

The details of the coating materials and coating ranges of the fuel injectors according to Japanese Patent Publication (A) No. 2004-84499 and Japanese Patent Publication (A) No. 2002-543330 simultaneously satisfying inhibited adhesion of deposits and durability are unknown. These could not be immediately used for practical application.

The fuel injector according to Japanese Patent Publication (A) No. 2001-280224 required provision of an insert at the valve seat of the needle, so there were the defects that the structure became complicated and the production cost rose.

### DISCLOSURE OF THE INVENTION

Therefore, the present invention has as its object the elimination of the above problems in the prior art and the provision of a fuel injector inhibiting the adhesion of deposits and simultaneously improving the durability by a simple configuration.

To achieve the above object, according to the present invention, there is provided a fuel injector having

a valve body provided with a main space receiving fuel and an injection hole and

a needle movably supported at the valve body and having a seal part at its front end, in which needle the movement causes the seal part to separate from or contact an inner surface of the valve body and thereby open or close a fuel passage communicating the main space and the injection hole of the valve body,

the fuel injector characterized in that

the injection hole of the valve body is covered by an injection hole coating comprised of a material with a lower adsorption and reactivity with oxygen compared with the material of the valve body itself, and

the seal part of the needle is covered by a seal part coating comprised of a material higher in liquid-repellency compared with the material of the needle itself and not forming a metal surface.

The inventors newly discovered that by coating an injection hole adjoining a combustion chamber and exposed to a high temperature by a material with a low adsorption and reactivity with oxygen and coating a seal part of a needle relatively separated from the combustion chamber and with a relatively low peak temperature by a material with a high liquid repellency and low oxygen adsorption energy, that is to say, employing selective coatings, it is possible to greatly reduce the deposits and simultaneously secure durability, and thereby completed the present invention.

Preferably, the material of the injection hole coating is gold and the material of the seal part coating is a silica-based coating material.

### BRIEF DESCRIPTION OF THE DRAWINGS

FIG. 1 is a cross-sectional view showing main parts of a fuel injector according to an embodiment of the present invention.

FIG. 2 is a graph comparing the rates of drop of fuel flow after actual engine tests for the coatings of the present invention and comparative examples.

FIG. 3 is a graph plotting the amount of formation of deposits in a test piece test against the heat of O₂ adsorption for the gold used for the present invention and other metals.

### BEST MODE FOR CARRYING OUT THE INVENTION

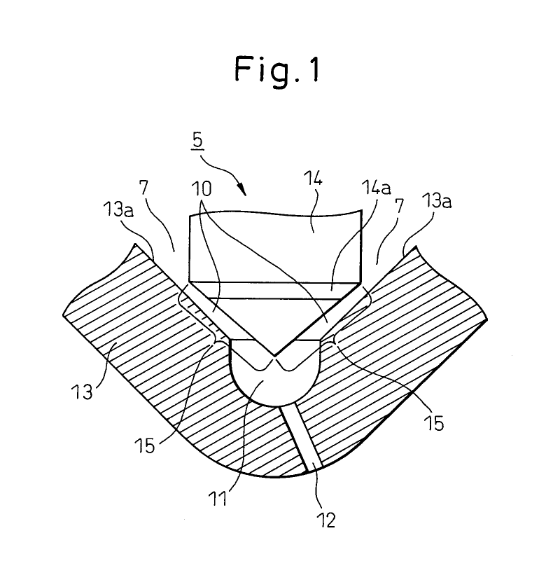

FIG. 1 shows the cross-section of the main parts of a fuel injector according to an embodiment of the present invention. The illustrated fuel injector 5 has a valve body 13 forming a hollow cylinder overall (overall illustration omitted). The cylindrical inside forms a main space 7 receiving the fuel. The front end part is provided with a substantially semispherical sack part 11 serving as a fuel reservoir. An injection hole 12 opening from the sack part 11 to the outside has a slant of a predetermined angle and a spread of a predetermined angle.

Inside the valve body 13, a needle 14 is supported so as to be able to move in its axial direction (in FIG. 1, vertical direction). The front end of the needle 14 forms a conical seal part 14a. A clearance between the seal part 14a and an inner surface 13a of the valve body 13 forms a fuel passage 10.

The illustrated state is the state with the seal part 14a of the needle 14 and the inner surface 13a of the valve body 13 separated. If the needle 14 is moved in the axial direction to bring the two into contact, the fuel passage 10 is closed.

That is, by the separation and contact of the seal part 14a and the inner surface 13a of the valve body 13 accompanying movement of the needle 14 in the axial direction, the fuel passage 10 between the needle seal part 14a and the valve body inner surface 13a is opened and closed, the main space 7 and the injection hole 12 are communicated via the sack part 11 or cut off from each other, and fuel injection from the injection hole 12 is correspondingly executed or stopped.

Note that the needle 14 is biased by a spring (not shown) provided in the valve body 13 in a direction closing the fuel passage 10 (downward in the figure).

On the other hand, by energizing a solenoid (not shown) provided in the valve body 13 so as to generate an attracting force and making the needle 14 move upward in the figure against the biasing force of the spring, the fuel passage 10 opens and the main space 7 and the injection hole 12 are communicated via the sack part 11.

By moving the needle 14 to control the opening and closing of the fuel passage 10 in this way, it is possible to inject the fuel in the main space 7 through the sack part 11 from the injection hole 12 at a predetermined timing intermittently into the combustion chamber (not shown).

According to the present invention, adhesion of deposits on the fuel injector 5 is inhibited and simultaneously the durability is improved by selective coating by plating or another coating means in accordance with the location as explained below.

First, the injection hole 12 has a high frequency of direct exposure to the high temperature, high pressure combustion gas from the adjoining combustion chamber, so prevention of adhesion of oxide-based deposits is important. For this reason, the material of the injection hole coating has to have heat resistance and have a low adsorption and reactivity with oxygen. The inner surface of the injection hole 12 is covered by a coating made of such a material.

As the material of the injection hole coating, a metal satisfying the above required properties, preferably a precious metal, particularly gold, is suitable.

On the other hand, the seal part 14a of the needle 14 faces the inner surface 13a of the valve body 13 and defines the fuel passage 10. In general, at least the injection hole 12 (in the illustrated example, also the sack part 11) is interposed between it and the combustion chamber, so compared with the injection hole 12, the frequency of exposure to the high temperature, high pressure combustion gas from the combustion chamber is low, so prevention of adhesion of deposits of metal salts such as ammonium sulfate and lithium sulfate contained in the fuel is important. For this reason, the material of the seal part coating does not require as high a heat resistance as the injection hole coating. Rather, it is necessary that the liquid repellency be high and no metal surface be formed. The seal part 14a is covered by a coating made of such a material.

As the material of the seal part coating, a non-metal material satisfying the above required properties is preferable. In particular, a silica-based liquid-repellent coating material is suitable. As a silica-based liquid-repellent coating material, a composition mainly comprised of SiO₂ and having as an added ingredient typically a polymer of a fluorine-based functional group in combination may be mentioned. As the polymer of a fluorine-based functional group, the polymer of tetrafluoroethylene, that is, polytetrafluoroethylene (PTFE), or other fluororesins are typical examples. However, the added ingredients do not have to be limited to this. The added ingredients used for liquid repellent coatings in the past may also be used.

By coating an injection hole 12 of a valve body 13 adjoining a combustion chamber and exposed to a high temperature by gold, which is high in chemical stability and resistant to oxidation, in this way, high temperature durability and inhibited adhesion of deposits can be simultaneously achieved. On the other hand, by coating a seal part 14a of a needle 14 exposed to a relatively low temperature by a silica-based liquid-repellent coating material resistant to adhesion of metal salts, inhibited adhesion of deposits can be achieved.

In this way, according to the present invention, by selectively applying coatings made of specific materials in accordance with the temperature and atmosphere conditions to which locations of the fuel injector where adhesion of deposits occurs are exposed, inhibited adhesion of deposits and durability can be simultaneously achieved by a simple configuration.

Note that in the example of FIG. 1, as a typical structure where deposits easily adhere, a structure provide with a sack part 11 serving as a fuel reservoir was shown, but the present invention gives the effects of inhibition of adhesion of deposits and improvement of durability regardless of the presence or absence of the sack part 11.

Further, for convenience in explanation, FIG. 1 showed a fuel injector 5 provided with a slit shaped injection hole 12, but the present invention is not limited to this. Similar effects are obtained even if applying the invention to a fuel injector of a structure provided with a plurality of injection holes (multi-hole nozzle) or a swirl nozzle.

### EXAMPLES

The selective coatings of the present invention were applied and engine tests conducted. The conditions of the engine tests were as follows:

<Engine Test Conditions>

Engine covered: In-line engine (L4)

Operating temperature: INJ front end temperature of 150° C.

Operating time: 40 hours

Fuel: high octane

As an invention example, the inner surface of the injection hole was coated with gold, while the needle seal part was given a liquid-repellant coating mainly comprised of SiO₂ to which a PTFE resin was added.

As comparisons, engine tests were run for the case of no coating and the case of coating both the injection hole and needle seal part with the same gold.

The flow rates of the fuel before and after the tests were measured for the above three cases. The rates of the drop in flow rates after the test compared with the flow rates before the tests were found and evaluated as the drop in the flow rate.

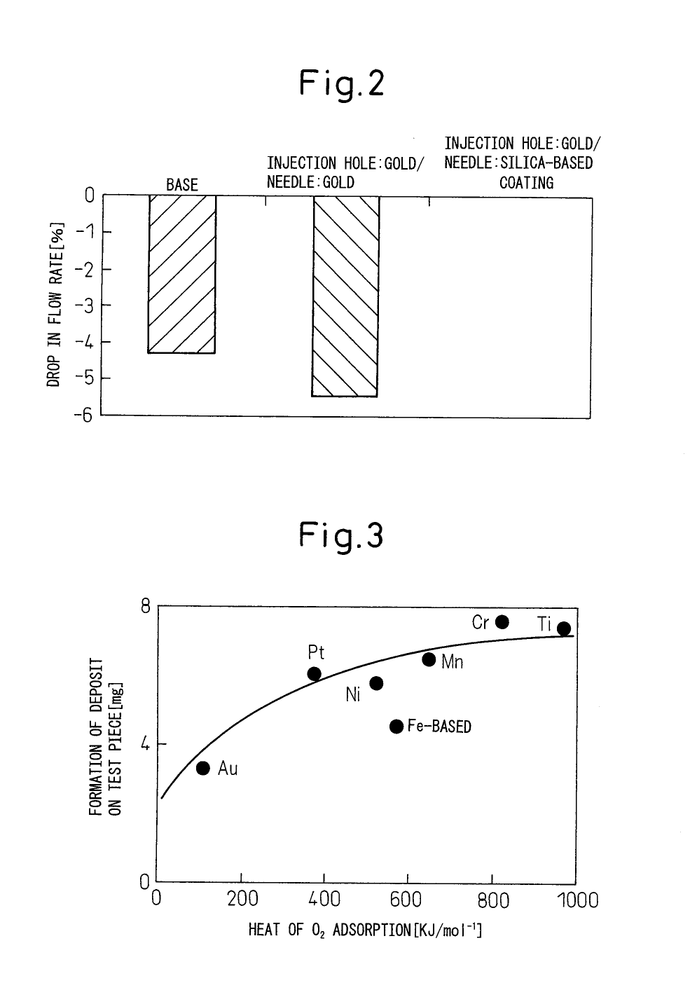

FIG. 2 summarizes the results of the engine tests as a graph. In FIG. 2, the abscissa shows the type of coating, while the ordinate shows the drop in the flow rate of the fuel after the test.

As shown in the figure, the drop in the flow rate in the base state with no coating was −4%.

As opposed to this, when coating both the injection hole and needle seal part with gold, the drop in the flow rate was −5.5% or conversely worse than the base state with no coating.

When coating the injection hole with gold and giving the needle seal part a silica-based liquid-repellent coating according to the present invention, there was no drop in the flow rate at all in the range of measurement precision.

In this way, according to the present invention, an extremely remarkable effect of inhibition of deposits is obtained by selectively using a gold coating and a silica-based liquid-repellent coating for the injection hole and the needle seal part.

Note that to confirm the superiority of the use of particularly gold among the various metals as the injection hole coating, test pieces were tested in an autoclave. The test conditions were as follows:

<Test Piece Test Conditions>

Atmosphere in autoclave: pressure 1 MPa, temperature 200° C.

Test method: Spraying test piece with combustion gas at a spray pressure of 2 MPa

Test piece: Coated by various metals shown in FIG. 3 by plating

FIG. 3 summarizes the results. In FIG. 3, the abscissa shows the heat of O₂ adsorption, while the ordinate shows the amount of formation of deposits.

As shown in the drawing, among the various metals tested, when covered by gold, the amount of formation of deposits was remarkably smaller compared with being covered by other metals. The lower the heat of O₂ adsorption of the abscissa, that is, the lower the adsorption of oxygen, the smaller the amount of formation of deposits observed as a general trend.

In the test results of the test pieces shown in the drawing, Ni and Fe are both relatively small in formation of deposits, but are far inferior compared to Au or Pt in durability at a high temperature, so are not suitable for practical application.

### INDUSTRIAL APPLICABILITY

The present invention is useful for a fuel injector of an in-line injector type internal combustion engine and can inhibit the adhesion of deposits and simultaneously improve the durability by a simple configuration.

### DESCRIPTION OF REFERENCES

5 fuel injector

7 main space

10 fuel passage

11 sack part (fuel reservoir)

12 injection hole

13 valve body

14 needle

14a seal part

15 coating surface

1. A fuel injector having
a valve body provided with a main space receiving fuel and an injection hole and
a needle movably supported at said valve body and having a seal part at its front end, in which needle said movement causes said seal part to separate from or contact an inner surface of said valve body and thereby open or close a fuel passage communicating the main space and the injection hole of the valve body,
said fuel injector characterized in that
said injection hole of the valve body is covered by an injection hole coating comprised of a material with a lower adsorption and reactivity with oxygen compared with the material of said valve body itself, and
said seal part of the needle is covered by a seal part coating comprised of a material higher in liquid-repellency compared with the material of said needle itself and not forming a metal surface.

2. A fuel injector as set forth in claim 1, said fuel injector characterized in that, in said fuel injector, the material of said injection hole coating is gold and the material of said seal part coating is a silica-based coating material.
